(19) United States
(12) Patent Application Publication
(10) Pub. No.: US 2026/0237318 A1
(43) Pub. Date: Aug. 13, 2026

(54) INFORMATION PROCESSING SYSTEM, NON-TRANSITORY COMPUTER READABLE MEDIUM, AND INFORMATION PROCESSING METHOD

(71) Applicant: FUJIFILM Business Innovation Corp., Tokyo (JP)

(72) Inventor: Kentaro OSAJIMA, Kanagawa (JP)

(73) Assignee: FUJIFILM Business Innovation Corp., Tokyo (JP)

(21) Appl. No.: 19/313,005

(22) Filed: Aug. 28, 2025

(30) Foreign Application Priority Data
Feb. 7, 2025 (JP) 2025-019501

(51) Int. Cl. G09B 7/02; H04N 1/00

(52) U.S. Cl. CPC G09B 7/02; H04N 1/00811; H04N 2201/0094

(57) ABSTRACT

An information processing system includes a processor configured to: divide, into a plurality of division units, an information group in which a plurality of pieces of unit information that includes at least one of a character and an image and forms one unit is arranged according to a predetermined arrangement basis; and input the information group for each of the division units to a similar information creation model that outputs similar information, which is similar to the unit information, when the unit information is input and cause the similar information to be output for each of the division units.

### CROSS-REFERENCE TO RELATED APPLICATIONS

This application is based on and claims priority under 35 USC 119 from Japanese Patent Application No. 2025-019501 filed Feb. 7, 2025.

### BACKGROUND

### Technical Field

The present disclosure relates to an information processing system, a non-transitory computer readable medium, and an information processing method.

### Related Art

Japanese Unexamined Patent Application Publication No. 2014-228957 discloses a teaching material creation support system including a first storage unit, a search unit, a generation unit, and a second storage unit. The first storage unit stores question content together with attribute information. The search unit receives a search condition specified by a user and searches for question content having attribute information matching the search condition. The generation unit arranges the question content selected by the user in accordance with the layout designated by the user and generates a preview display of the arranged question content. The second storage unit stores the information on the arranged question content. At least one of the question contents includes a main question including a plurality of sub-questions. Attribute information is associated with a main question included in the question content, and attribute information independent of the attribute information of the main question is associated with each of the plurality of sub-questions constituting the main question.

Japanese Unexamined Patent Application Publication No. 2021-113961 discloses a test question generation system including a processing device that generates test questions. The processing device includes a storage unit and a processing unit. The storage unit stores a plurality of question statements of the past test questions for each question category. The processing unit generates a question statement of a predicted test question. When a plurality of question formats and a ratio of the question formats are set, the processing unit predicts the number of questions in the category of questions to be generated based on the number of questions for each category of the past test questions stored in the storage unit. Based on the question statement of the past test question in accordance with the predicted number of questions in the category, the processing unit generates a question statement in accordance with the question format at the set ratio of question formats and generates a collection of questions.

### SUMMARY

As an information processing system, an information processing system in which a processor inputs an information group, in which a plurality of pieces of unit information that includes at least one of a character and an image and forms one unit is arranged according to a predetermined arrangement basis, to a similar information creation model and causes similar information to be output may be considered. When the unit information is input, the similar information creation model outputs similar information that is similar to the unit information.

When the information group is collectively input to the similar information creation model in the information processing system, the similar information may be output without considering the arrangement basis. Therefore, it may be difficult to construct a similar information group in which a plurality of pieces of similar information is arranged according to the arrangement basis.

Aspects of non-limiting embodiments of the present disclosure relate to making it easy to construct a similar information group in which a plurality of pieces of similar information output from a similar information creation model is arranged according to a predetermined arrangement basis, as compared to a case where a processor collectively inputs, to the similar information creation model, an information group in which a plurality of pieces of unit information is arranged according to the predetermined arrangement basis.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing system including a processor configured to: divide, into a plurality of division units, an information group in which a plurality of pieces of unit information that includes at least one of a character and an image and forms one unit is arranged according to a predetermined arrangement basis; and input the information group for each of the division units to a similar information creation model that outputs similar information, which is similar to the unit information, when the unit information is input and cause the similar information to be output for each of the division units.

### BRIEF DESCRIPTION OF THE DRAWINGS

Exemplary embodiments of the present disclosure will be described in detail based on the following figures, wherein:

FIG. 1 is a schematic view illustrating an example of an information processing system according to the present exemplary embodiment;

FIG. 2 is a block diagram illustrating an example of a hardware configuration of a multifunction peripheral according to the present exemplary embodiment;

FIG. 3 is a block diagram illustrating an example of a functional configuration of a control device of a multifunction peripheral according to the present exemplary embodiment;

FIG. 4 is a block diagram illustrating an example of a hardware configuration of a server device according to the present exemplary embodiment;

FIG. 5 is a flowchart illustrating an example of a process flow for creating a similar question according to the present exemplary embodiment;

FIG. 6 is a diagram illustrating an example of a first page of a collection of questions forming a question group according to the present exemplary embodiment;

FIG. 7 is a diagram illustrating an example of a second page of the collection of questions forming the question group according to the present exemplary embodiment;

FIG. 8 is a diagram illustrating an example of a third page of the collection of questions forming the question group according to the present exemplary embodiment;

FIG. 9 is a diagram illustrating an example of an input screen on which a user can input content information indicating content of a question group for each division unit according to the present exemplary embodiment;

FIG. 10 is a diagram illustrating an example of a prompt for a similar question creation model according to the present exemplary embodiment;

FIG. 11 is a diagram illustrating an example of character strings and similar questions output from the similar question creation model according to the present exemplary embodiment;

FIG. 12 is a diagram illustrating an example of arrangement of similar questions according to an arrangement basis according to the present exemplary embodiment;

FIG. 13 is a diagram illustrating an example of representing a blank space using a rectangular graphic in questions according to the present exemplary embodiment; and

FIG. 14 is a diagram illustrating an example of converting a blank space using a rectangular graphic into a blank in character information in the questions illustrated in FIG. 13.

### DETAILED DESCRIPTION

Exemplary embodiments of the present disclosure will be described below with reference to the drawings.

### Information Processing System 10

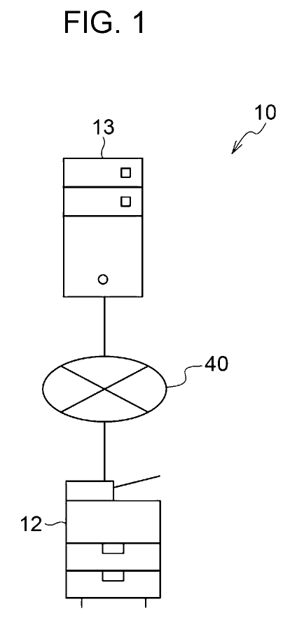

An information processing system 10 according to the present exemplary embodiment will be described. FIG. 1 is a schematic view illustrating the information processing system 10 according to the present exemplary embodiment.

As illustrated in FIG. 1, the information processing system 10 according to the present exemplary embodiment includes a multifunction peripheral 12 and a server device 13. The multifunction peripheral 12 and the server device 13 are connected to each other via a network 40 such as the Internet. The multifunction peripheral 12 and the server device 13 are capable of transmitting and receiving various types of information to and from each other via the network 40.

The information processing system 10 may include other devices other than the multifunction peripheral 12 and the server device 13. A plurality of devices constituting the information processing system 10, including the other devices, are connected to each other via the network 40.

### Multifunction Peripheral 12

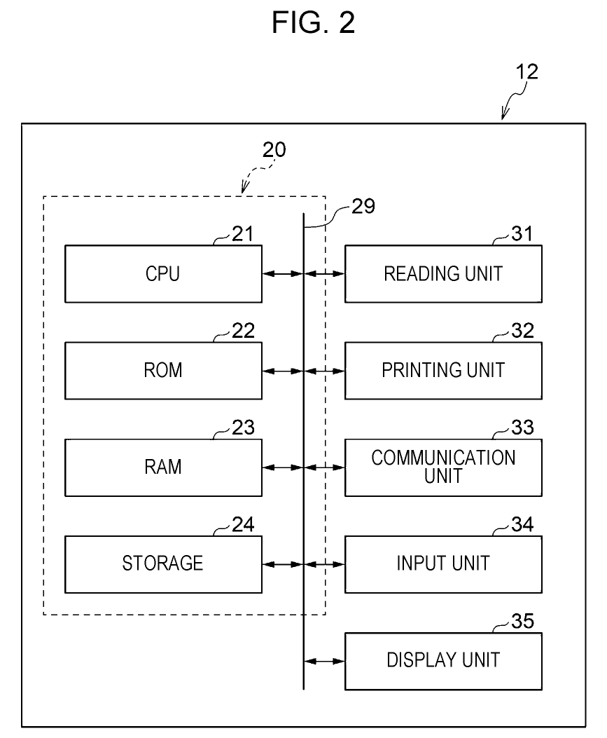

The multifunction peripheral 12 is a device including a processor. The multifunction peripheral 12 is a device capable of executing processing such as image reading and printing. Specifically, as illustrated in FIG. 2, the multifunction peripheral 12 includes a control device 20, a reading unit 31, a printing unit 32, a communication unit 33, an input unit 34, and a display unit 35. The control device 20, the reading unit 31, the printing unit 32, the communication unit 33, the input unit 34, and the display unit 35 are connected to each other with a bus 29.

The reading unit 31 is a component that reads information such as characters and images printed on a reading target such as a printed material. The reading unit 31 optically reads the information of the reading target and converts the information into an electrical signal to generate image information.

The printing unit 32 is a component that prints information such as characters and images on a recording medium such as paper. The printing unit 32 prints the information on a recording medium by, for example, an electrophotographic method that performs charging, exposure, development, transfer, and fixing processes. The printing unit 32 may print the information on a recording medium by another method such as an inkjet method.

The communication unit 33 is a communication interface and is a component for communicating with another device (for example, the server device 13). Specifically, the communication unit 33 communicates with another device by using a communication unit such as wired communication, wireless communication, the Internet, an intranet, or a public line such as a telephone line. The communication unit may be a communication unit using voice, light, vibration, an image, or the like.

The input unit 34 is a component to which an instruction is input by a user. Specifically, the input unit 34 includes, for example, input keys (for example, a keyboard and operation buttons) and a touch panel with which a user performs an input operation. The user is an example of a user.

The display unit 35 displays presentation information, which is presented to the user, and thus notifies the user of the presentation information. The display unit 35 is, for example, a liquid crystal display or an organic electroluminescence (EL) display.

The display unit 35 may function as the input unit 34. In this case, the input unit includes, for example, a resistive touch panel or a capacitive touch panel and receives an instruction from the user through a touch operation performed by the user.

The control device 20 is a device that controls each unit of the multifunction peripheral 12. The control device 20 functions as a computer, and as illustrated in FIG. 2, includes a central processing unit (CPU) 21, a read only memory (ROM) 22, a random access memory (RAM) 23, and a storage 24. The CPU 21, the ROM 22, the RAM 23, and the storage 24 are connected to each other with the bus 29.

The CPU 21 is a central processing unit that executes various programs including an information processing program and controls each unit. The ROM 22 stores various programs including an information processing program and various types of data. The RAM 23 temporarily stores programs or data as a work area. The storage 24 is configured with a storage medium such as a hard disk drive (HDD), a solid state drive (SSD), or a flash memory, and stores various programs including an operating system and various types of data. The information processing program may be stored in the storage 24.

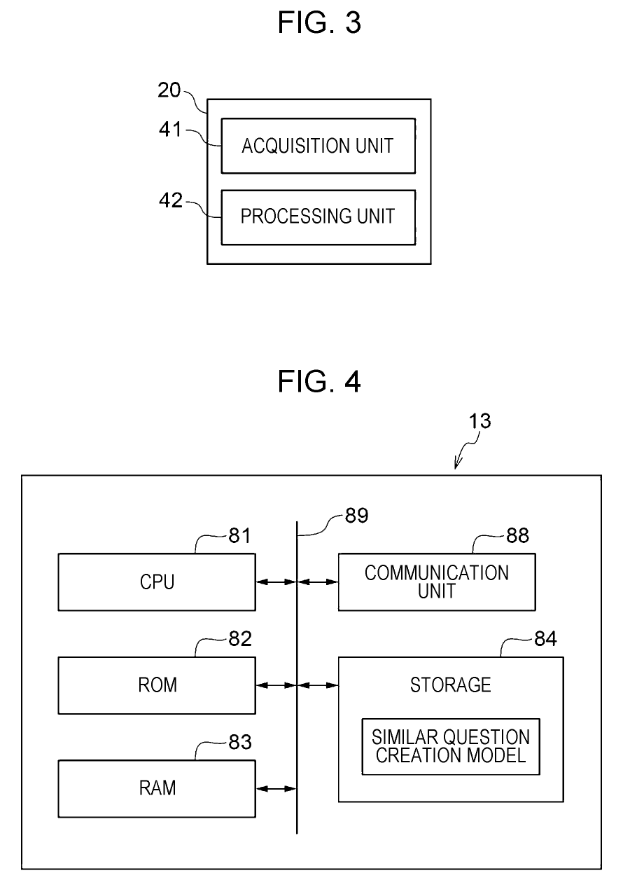

In the control device 20, the CPU 21 reads various programs including an information processing program from the ROM 22 or the storage 24 and executes the program using the RAM 23 as a work area. When the CPU 21 executes the information processing program, various functions for controlling each unit of the multifunction peripheral 12 are implemented. A functional configuration implemented by cooperation between the CPU 21 as hardware resources and an information processing program as software resources will be described below. FIG. 3 is a block diagram illustrating an example of a functional configuration of the control device 20 according to the present exemplary embodiment.

In the control device 20, as illustrated in FIG. 3, the CPU 21 executes an information processing program to function as an acquisition unit 41 and a processing unit 42.

The acquisition unit 41 acquires various user instructions given by the user through the input unit 34. For example, the acquisition unit 41 acquires, as a user instruction, an instruction (hereinafter referred to as "creation instruction") to create a similar question that is similar to a question in a question group.

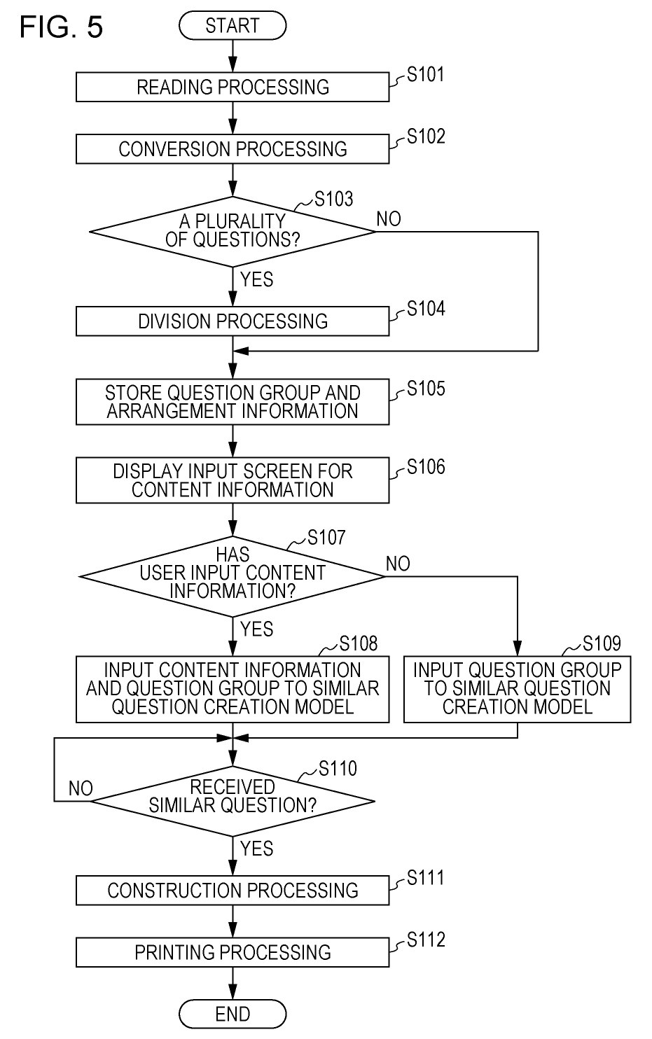

When the acquisition unit 41 acquires the creation instruction, the processing unit 42 executes a similar question creation process flow (see FIG. 5) described below to create a similar question that is similar to a question in a question group.

### Server Device 13

The server device 13 functions as a computer, and as illustrated in FIG. 4, includes a central processing unit (CPU) 81, a read only memory (ROM) 82, a random access memory (RAM) 83, a storage 84, and a communication unit 88. The CPU 81, the ROM 82, the RAM 83, the communication unit 88, and the storage 84 are connected to each other with a bus 89.

The communication unit 88 is a communication interface and is a component for communicating with another device (for example, the multifunction peripheral 12). Specifically, the communication unit 88 communicates with another device by using a communication unit such as wired communication, wireless communication, the Internet, an intranet, or a public line such as a telephone line. The communication unit may be a communication unit using voice, light, vibration, an image, or the like.

The CPU 81 is a central processing unit that executes various programs including an information processing program and controls each unit. The ROM 82 stores various programs including an information processing program and various types of data. The RAM 83 temporarily stores programs or data as a work area. The storage 84 is configured with a storage medium such as a hard disk drive (HDD), a solid state drive (SSD), or a flash memory, and stores various programs including an operating system and various types of data including a similar question creation model described below. The information processing program may be stored in the storage 84.

In the server device 13, the CPU 81 reads various programs including an information processing program from the ROM 82 or the storage 84 and executes the program using the RAM 83 as a work area. When the CPU 81 executes the information processing program, various types of processing are executed. For example, the CPU 81 executes processing to output a similar question that is similar to a question input to the similar question creation model.

### Process Flow for Creating Similar Question

Next, an example of a process flow for creating a similar question (hereinafter, simply referred to as a process flow) executed by the information processing system 10 will be described. FIG. 5 is a flowchart illustrating an example of the process flow executed by the information processing system 10. The process flow is an example of an information processing method.

For example, when the CPU 21 acquires a creation instruction to create a similar question that is similar to a question in a question group, execution of this process flow starts.

Here, the question is information indicating a question asking for an answer. Examples of the question include questions of regularly scheduled tests at school, admission tests, and recruitment tests. According to the present exemplary embodiment, the question includes, for example, character information. The question group is a collection in which a plurality of questions is arranged according to a predetermined arrangement basis. The question group is an example of an information group. In the information group, a plurality of pieces of unit information is arranged according to a predetermined arrangement basis.

A single question (i.e., one question) is an example of the unit information. When the question group includes a plurality of main questions including a sub-question as one question, the sub-question is an example of the unit information.

The question group further includes an answer field and a suggested answer to a question. An answer field and a suggested answer are provided for each question. When the question group has a main question including a sub-question, an answer field and a suggested answer are provided for each sub-question. The answer field is information indicating a field in which an answer to the question is described. The suggested answer is information indicating an example of the answer to the question. In this specification, a printed material on which a question group is printed is referred to as a "collection of questions".

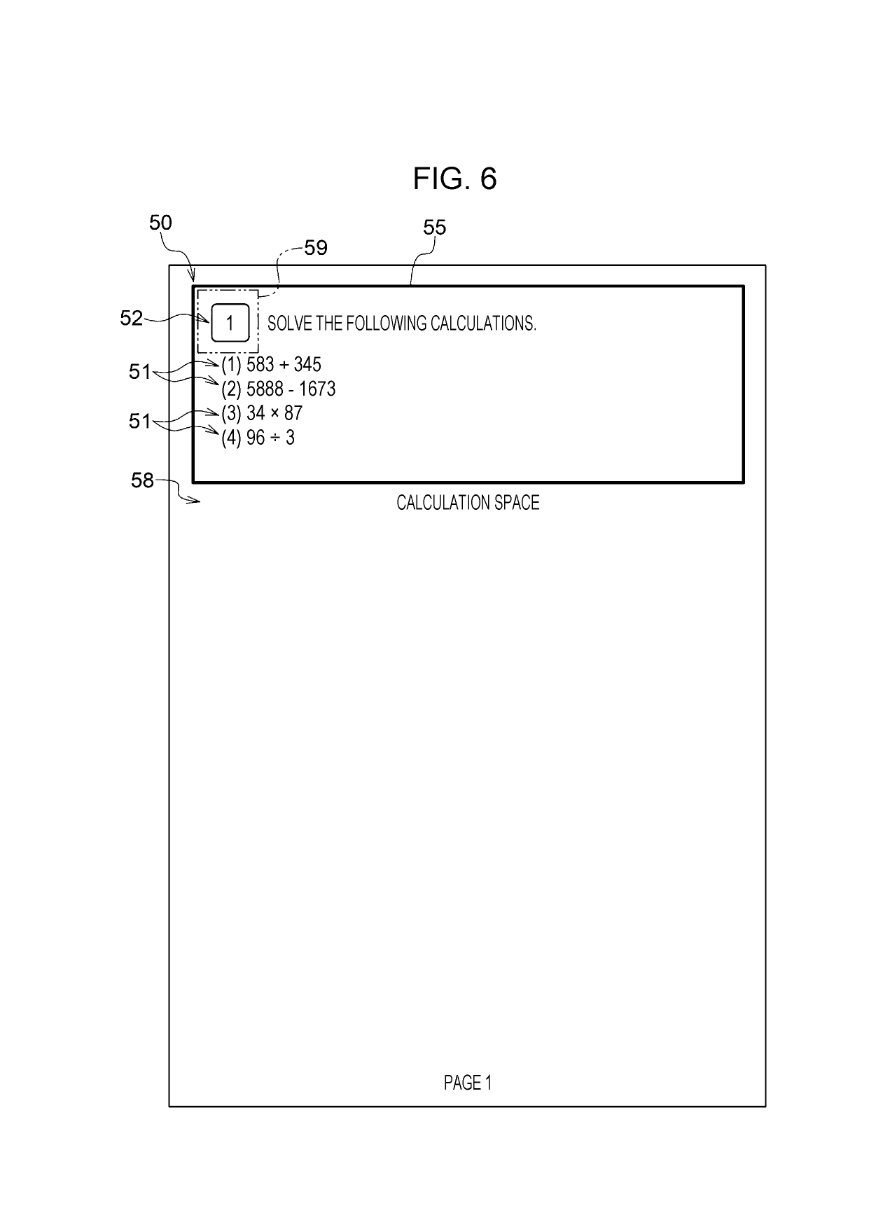

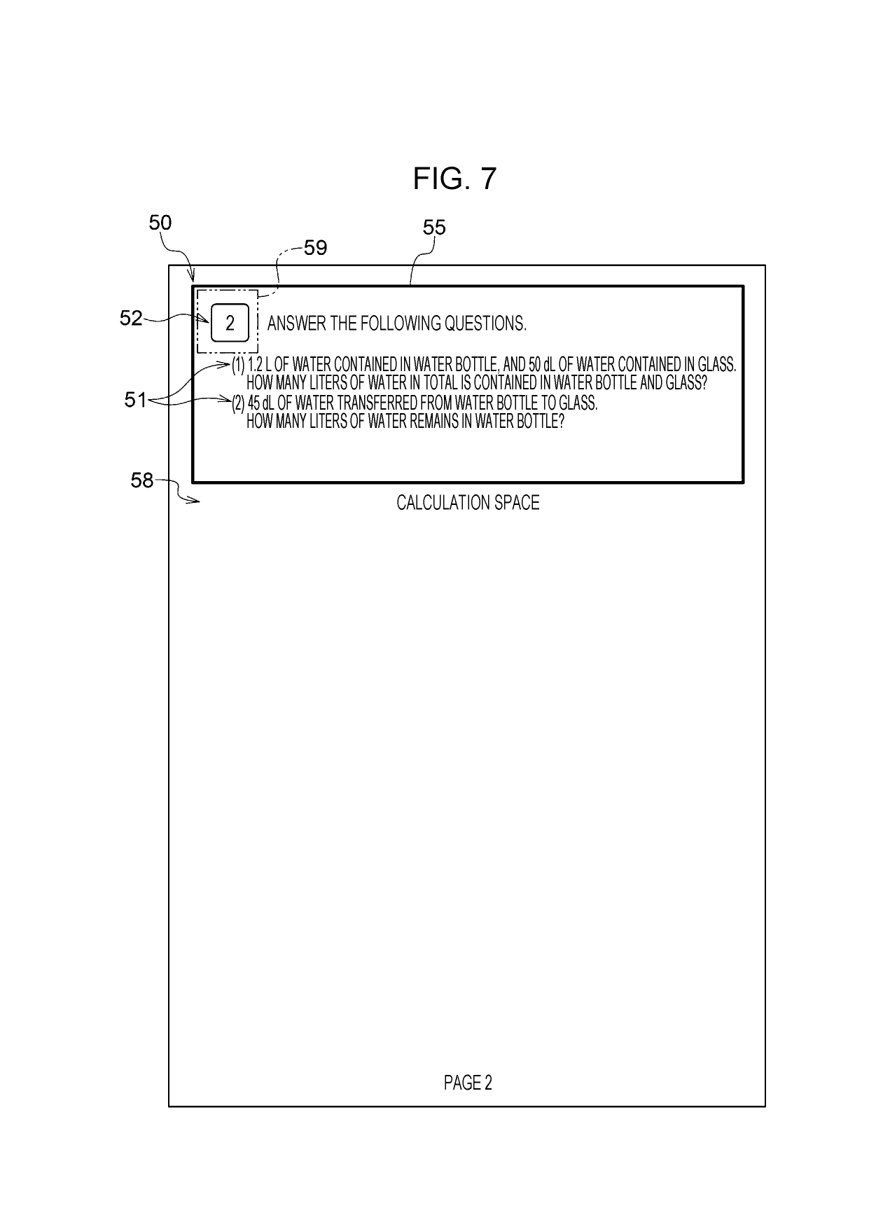

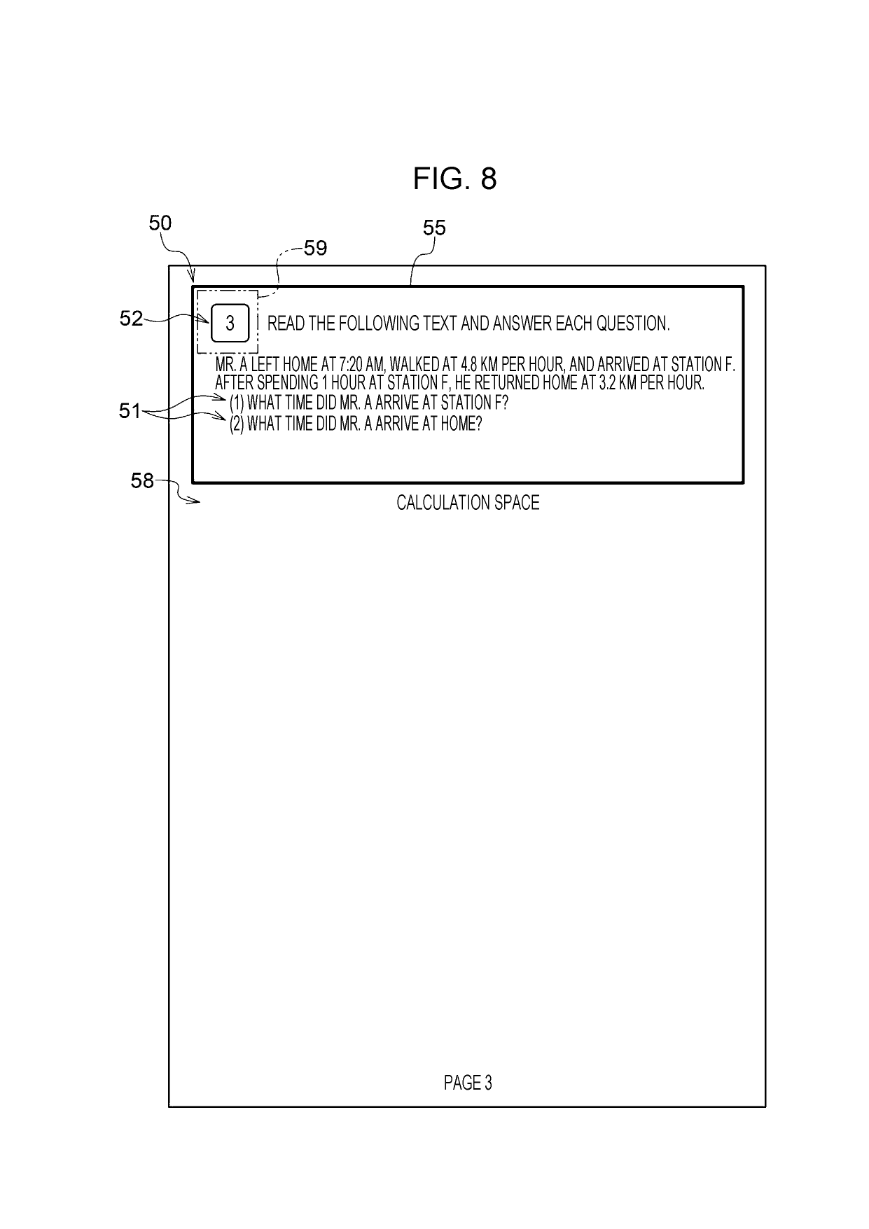

According to the present exemplary embodiment, as an example, arithmetic question groups are illustrated in FIGS. 6, 7, and 8. FIGS. 6, 7, and 8 illustrate the first to third pages of the collection of questions forming the question group. In the examples illustrated in FIGS. 6, 7, and 8, a question group 50 includes a plurality of main questions 52 including a plurality of sub-questions 51. In the examples illustrated in FIGS. 6, 7, and 8, the following (1), (2), (3), and (4) are used as arrangement bases.

(1) Characters are written horizontally in each of the main questions 52 including each of the sub-questions 51.

(2) Each of the main questions 52 is placed on each page in the collection of questions.

(3) Each of the main questions 52 is surrounded by a frame 55.

(4) A margin is provided as a calculation space 58 under the frame 55.

Moreover, the arrangement bases are not limited to the above-described examples. For example, the arrangement basis may be at least one of the following: the characters indicating the question content are written vertically; a plurality of main questions is provided on each page in the collection of questions; and the main questions are separated by a display other than a frame.

When this flow starts, in step S101, the CPU 21 causes the reading unit 31 of the multifunction peripheral 12 to execute reading processing to read a question group in the collection of questions. By executing the reading processing, the reading unit 31 generates the image information indicating the read image of the question group. Then, the CPU 21 proceeds to step S102.

In step S102, the CPU 21 executes conversion processing to convert the image information indicating the read image, which is read by the multifunction peripheral 12, into information (hereinafter referred to as "conversion information") recognizable by the similar question creation model.

When the information recognizable by the similar question creation model is character information (i.e., text data), examples of the conversion processing include OCR processing to convert image information into character information. OCR is optical character recognition. Then, the CPU 21 proceeds to step S103.

In step S103, the CPU 21 determines whether the conversion information includes a plurality of questions. When it is determined that the conversion information includes a plurality of questions (step S103: YES), the CPU 21 proceeds to step S104 and, when it is determined that the conversion information does not include a plurality of questions (step S103: NO), proceeds to step S105. The case where it is determined that the conversion information does not include a plurality of questions may be the case where it is determined that the conversion information includes only a single question.

In step S104, the CPU 21 executes division processing to divide the question group into a plurality of division units. The division unit is a unit having a plurality of questions. That is, in the division processing, the CPU 21 divides into a plurality of parts for a plurality of questions. The number of questions included in each division unit may differ. When the question group includes a plurality of main questions including sub-questions, the question group is divided, for example, for each main question in the division processing.

In the division processing, the CPU 21 divides the question group into a plurality of division units based on the read image of the question group read by the multifunction peripheral 12. To be specific, the CPU 21 divides the information group into a plurality of division units based on the basis information that is included in the read image and is set by the user.

The basis information corresponds to, for example, the position of the numerical value indicating the number of the main question that includes the sub-question. In this case, for example, the user can previously set the position of the numerical value on the read image. FIGS. 6, 7, and 8 illustrate an example in which the position of the numerical value is located at the upper left of each page of the collection of questions. In this case, the user previously sets an upper left region 59 as the position of the numerical value on the read image.

The basis information may be, for example, a keyword. In this case, for example, the division unit is grasped by keyword search.

In the division processing, the CPU 21 grasps the numerical value of the region set by the user from the conversion information. The CPU 21 divides the pages, as a division unit, from the page where the numerical value is placed to the page before the page where the subsequent numerical value is placed. Then, the CPU 21 proceeds to step S105.

In the division processing, at least a part of the division units may be a unit having a plurality of questions. In other words, in the division processing, a part of the division units may be a unit having only one question. That is, in the division processing, a question statement may be divided into a plurality of questions and one question.

In step S105, the CPU 21 executes storage processing to store the divided question groups in the storage 24 for each division unit. Further, in step S105, the CPU 21 stores the arrangement information indicating a predetermined arrangement basis in association with the question group. Then, the CPU 21 proceeds to step S106.

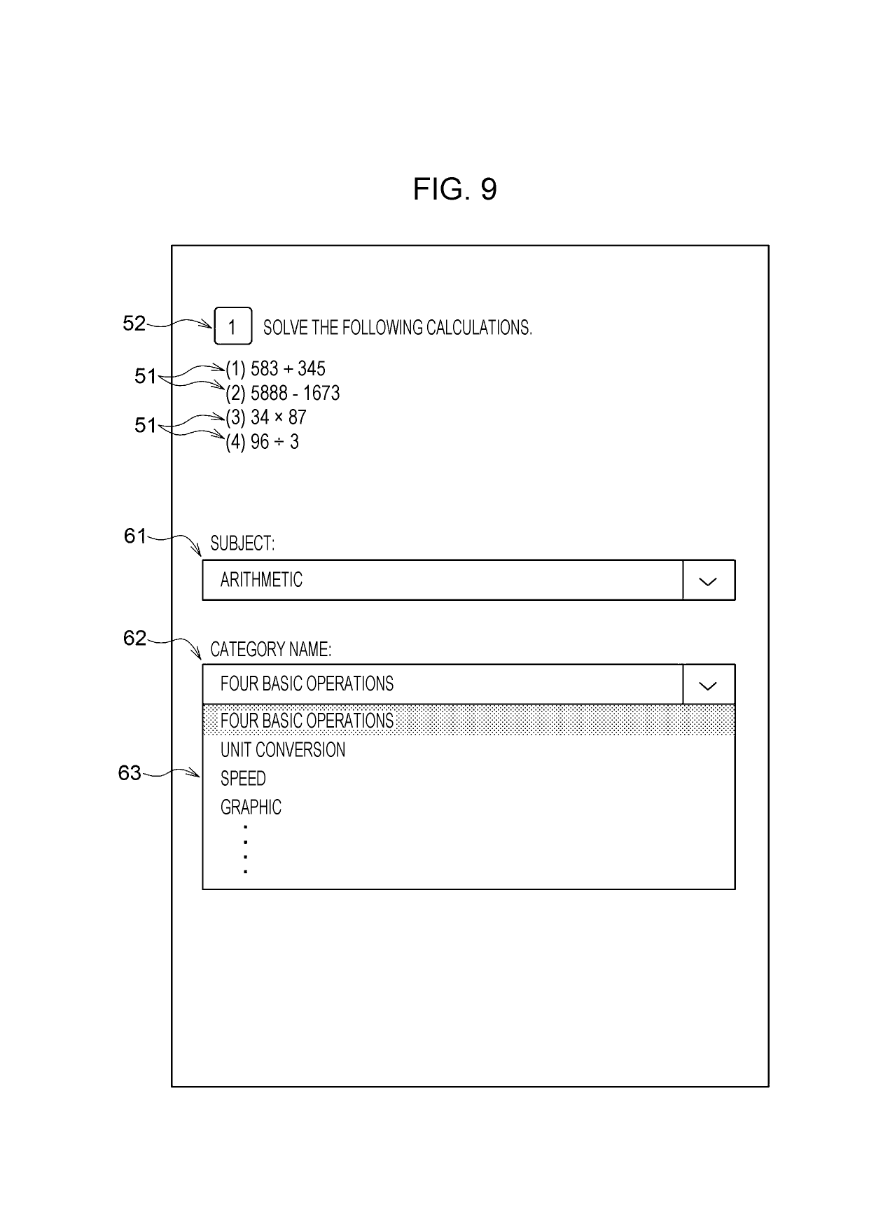

In step S106, the CPU 21 executes display processing to display an input screen (see FIG. 9) on the display unit 35. The input screen is a screen on which the user can input the information (hereinafter referred to as "content information") indicating the content of the question group for each division unit.

The content information corresponds to, for example, a subject and a category for each main question as a division unit (see FIG. 9). On the input screen illustrated in FIG. 9, for example, lists 63 of a subject 61 and a category 62 are prepared in advance, and a selection can be made from the lists 63. With the user's input, the user can set the subject 61 and the category 62 for each main question. The subject 61 and the category 62 are examples of classification. As described above, according to the present exemplary embodiment, the classification can be set for each division unit. In other words, the above-described division processing may be referred to as processing to divide into division units according to classification such as a subject and a category. Then, the CPU 21 proceeds to step S107.

In the above example, a selection is made from the list, but the user may directly input the subject 61 and the category 62 through a keyboard or the like.

In step S107, the CPU 21 determines whether the user has input the content information. The CPU 21 proceeds to step S108 when it is determined that the user has input the content information (step S107: YES), and proceeds to step S109 when it is determined that the user has not input the content information (step S107: NO).

In step S108, the CPU 21 inputs the content information together with the question group to the similar question creation model of the server device 13 for each division unit. The similar question creation model is a learned model that, when a question is input, outputs a similar question that is similar to the question. The similar question creation model is generated by, for example, performing machine learning in advance using learning data based on an assumed question. With the similar question creation model, for example, the character information of a question is recognized, and character information is output as a similar question. The similar question creation model outputs the similar question in consideration of the content information, and therefore, when the content information is input together with the question group, the quality of the similar question is improved.

A similar question is a question that belongs to the same category as the question. According to the present exemplary embodiment, a question with the same subject and category is a similar question. The similar question is an example of similar information. The similar question creation model is an example of a similar information creation model.

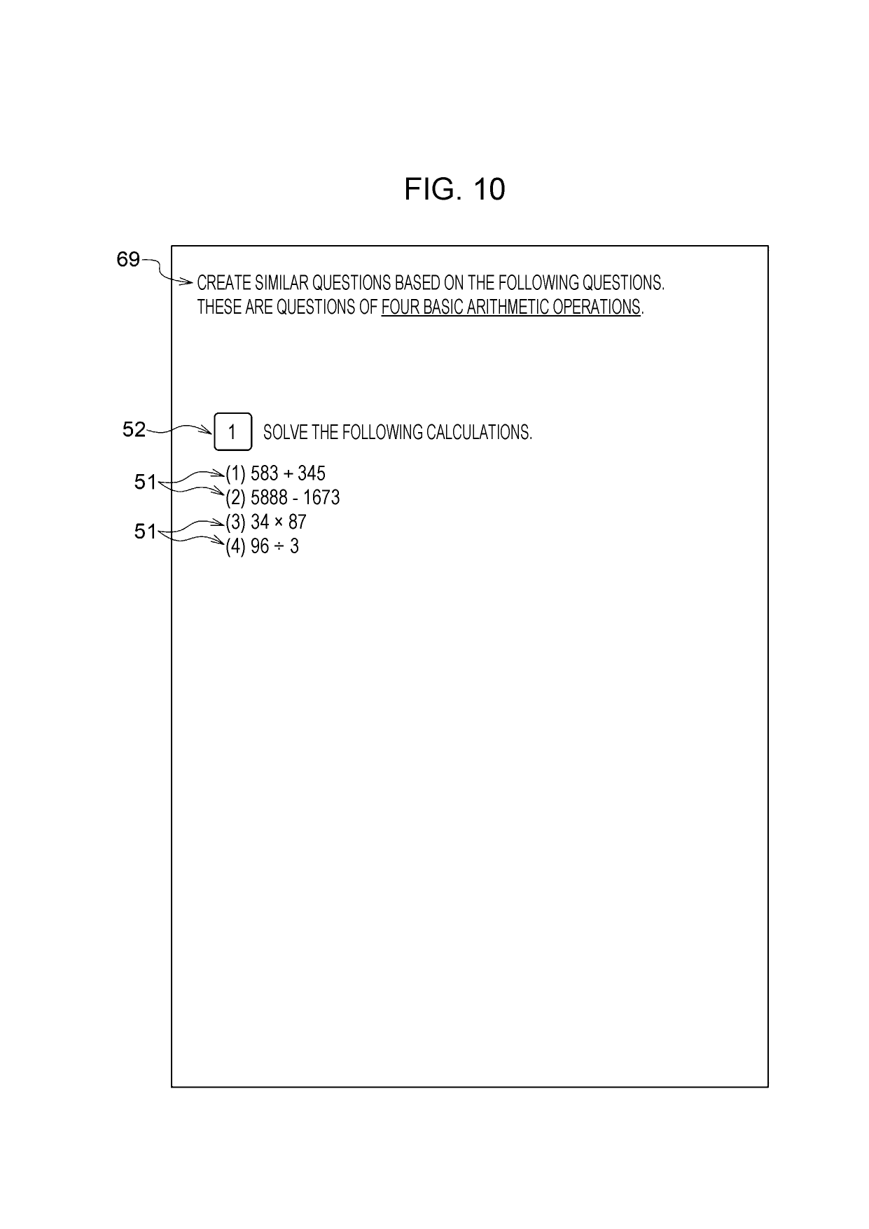

For example, as illustrated in FIG. 10, the CPU 21 creates a prompt 69 (i.e., instruction) for the similar question creation model and inputs the prompt 69 to the similar question creation model. The CPU 21 creates the prompt 69 based on the content information input by the user. For example, the CPU 21 may apply the subject and the category input by the user to a template prepared in advance (see the underlined part in FIG. 10) and input the subject and the category to the similar question creation model. When the template is prepared in advance, the information on the template is stored in the storage 24 or the like.

In step S108, the CPU 21 inputs the content information together with the question group to the similar question creation model for each division unit and thus causes the similar question creation model to output the similar question for each division unit. Then, the CPU 21 proceeds to step S110.

In step S109, the CPU 21 inputs the question group to the similar question creation model of the server device 13 for each division unit. In step S109, the CPU 21 inputs the question group to the similar question creation model for each division unit without inputting the content information and thus causes the similar question creation model to output the similar question for each division unit. Then, the CPU 21 proceeds to step S110.

In step S110, the CPU 21 determines whether the similar question has been received. When it is determined that the similar question has been received (step S110: YES), the CPU 21 proceeds to step S111 and, when it is determined that the similar question has not been received (step S110: NO), repeats step S110 until it is determined that the similar question has been received.

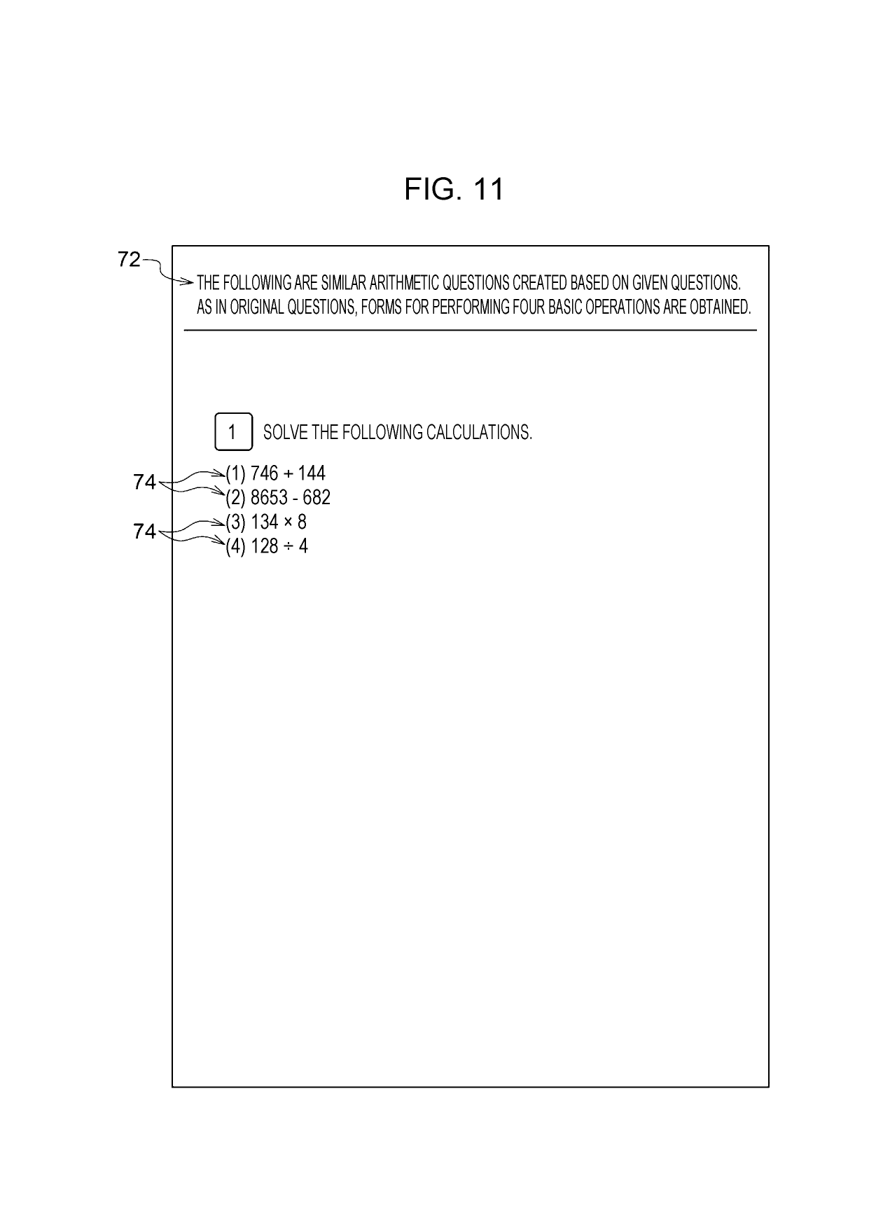

As illustrated in FIG. 11, the similar question creation model outputs a character string 72 and a similar question 74. Furthermore, the similar question creation model outputs an answer field (hereinafter referred to as "similar answer field") and a suggested answer (hereinafter referred to as "similar suggested answer") corresponding to the similar question 74. For example, the CPU 21 stores the similar question 74 in the storage 24 in association with the input question. Furthermore, for example, the CPU 21 stores the similar answer field and the similar suggested answer in the storage 24 in association with the similar question 74.

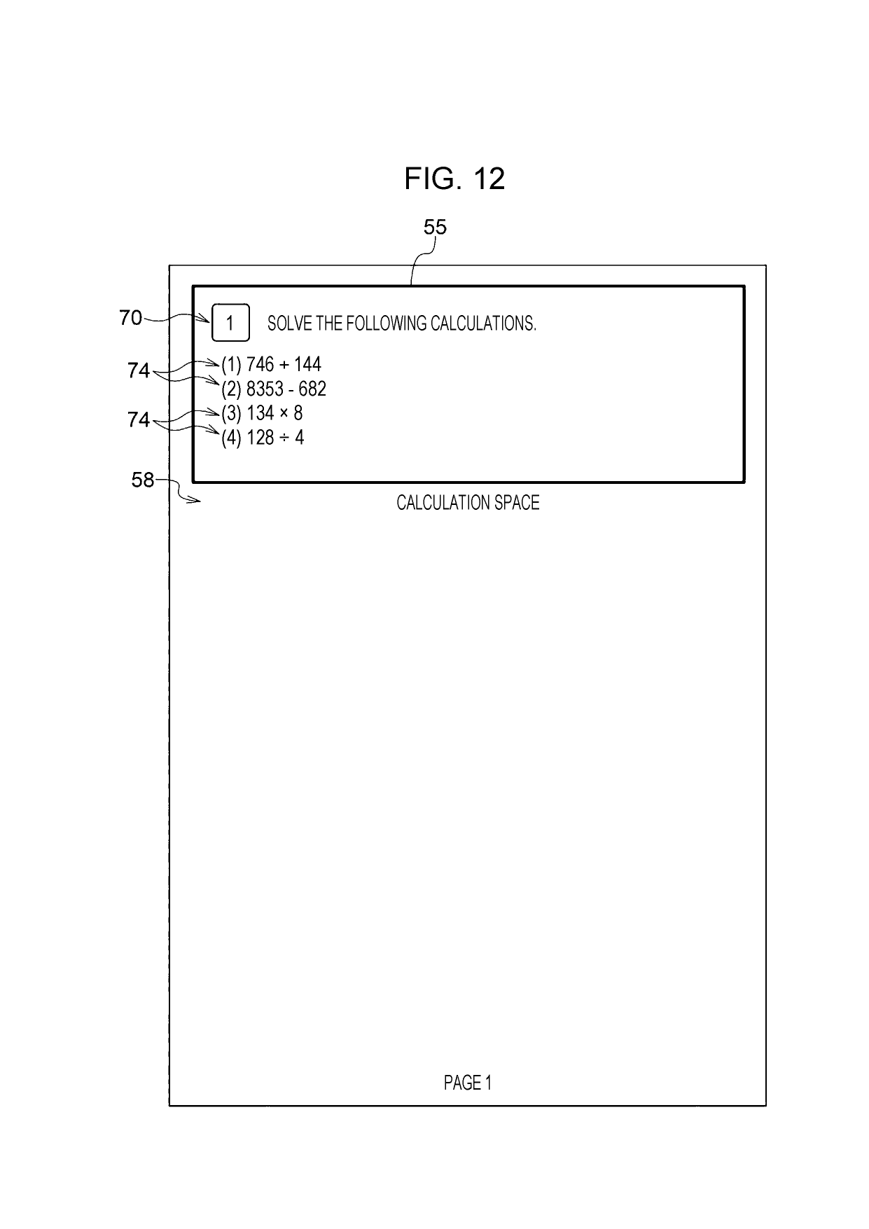

In step S111, as illustrated in FIG. 12, the CPU 21 executes construction processing to arrange the plurality of similar questions 74 and construct a similar question group 70 based on the arrangement basis stored in step S105. Thus, the question group 50 illustrated in FIG. 6 is replaced with the similar question group 70 (see FIG. 12). Then, the CPU 21 proceeds to step S112.

In step S112, the CPU 21 causes the printing unit 32 of the multifunction peripheral 12 to execute printing processing to print the similar question group on a recording medium. In step S112, the CPU 21 causes the printing unit 32 of the multifunction peripheral 12 to execute printing processing to print the similar answer field on a recording medium. Thus, the printing unit 32 prints the similar question group and the similar answer field on a recording medium.

Moreover, the CPU 21 does not print out the similar suggested answer. For example, when the CPU 21 acquires a separate instruction from the user, the printing of the similar suggested answer may be executed. In this manner, the similar question and the similar suggested answer may be separately presented to the user. Then, the CPU 21 ends this flow.

### Effect According to Present Exemplary Embodiment

According to the present exemplary embodiment, the CPU 21 divides the question group, in which the plurality of questions is arranged according to a predetermined arrangement basis, into a plurality of division units, inputs the question group to the similar question creation model for each division unit, and causes the similar question to be output for each division unit.

Thus, as compared to a case where the CPU 21 collectively inputs the question group to the similar question creation model, it is easy to construct the similar question group in which the plurality of similar questions output from the similar question creation model is arranged according to the arrangement basis.

According to the present exemplary embodiment, at least a part of the division units is a unit having a plurality of questions. Therefore, as compared to a case where all the division units are units having one question, the processing time of the division processing for dividing the question group into a plurality of division units is reduced.

To be more specific, the CPU 21 divides the question group for each main question, inputs the question group to the similar question creation model for each main question, and causes the similar question to be output for each of the main questions. Thus, as compared to a case where the CPU 21 divides the question group for each sub-question, the processing time of the division processing for dividing the question group into a plurality of division units is reduced.

According to the present exemplary embodiment, the CPU 21 divides the question group into a plurality of division units based on the read image of the question group read by the reading unit 31. Thus, it is possible to construct the similar question group from the question group printed on the recording medium.

According to the present exemplary embodiment, the CPU 21 divides the question group into a plurality of division units based on the basis information that is included in the read image and is set by the user. Thus, when the user sets the basis information in accordance with each situation, similar questions are less likely to be output without considering the arrangement basis. As a result, as compared to a case where the CPU 21 divides the question group into a plurality of division units based on the preset basis information, it is easy to construct the similar question group in which the plurality of similar questions output from the similar question creation model is arranged according to the arrangement basis.

According to the present exemplary embodiment, the CPU 21 inputs the content information indicating the content of the question group together with the question group to the similar question creation model for each division unit and causes the similar question to be output for each division unit.

Thus, as compared to a case where the CPU 21 inputs only the question group to the similar question creation model, it is easy to construct the similar question group in which the plurality of similar questions output from the similar question creation model is arranged according to the arrangement basis.

According to the present exemplary embodiment, the CPU 21 inputs the classification as the content information set by the user together with the question group to the similar question creation model for each division unit. Thus, as compared to a case where the CPU 21 inputs the preset content information to the similar question creation model, it is easy to construct the similar question group in which the plurality of similar questions output from the similar question creation model is arranged according to the arrangement basis.

According to the present exemplary embodiment, the CPU 21 constructs the similar question group in which the plurality of similar questions output from the similar question creation model is arranged according to the arrangement basis. Thus, the user does not need to construct the similar question group by using the similar question output from the similar question creation model.

According to the present exemplary embodiment, the information processing system 10 includes the printing unit that prints the similar question group on the recording medium. Thus, the user can obtain the similar question group printed on the recording medium.

According to the present exemplary embodiment, the CPU 21 causes the similar question creation model to output the similar question and the similar suggested answer for each division unit and separately presents the similar question and the similar suggested answer to the user. Thus, the user can answer the similar question without recognizing the similar suggested answer.

### Modification of Process Flow

When the question includes a graphic, the CPU 21 may convert the graphic into a symbol in step S102. Thus, in step S108 or step S109, the CPU 21 inputs the question group, in which the graphic has been converted into the symbol, to the similar question creation model. As the symbol, for example, a symbol included in character information (that is, text data) is used.

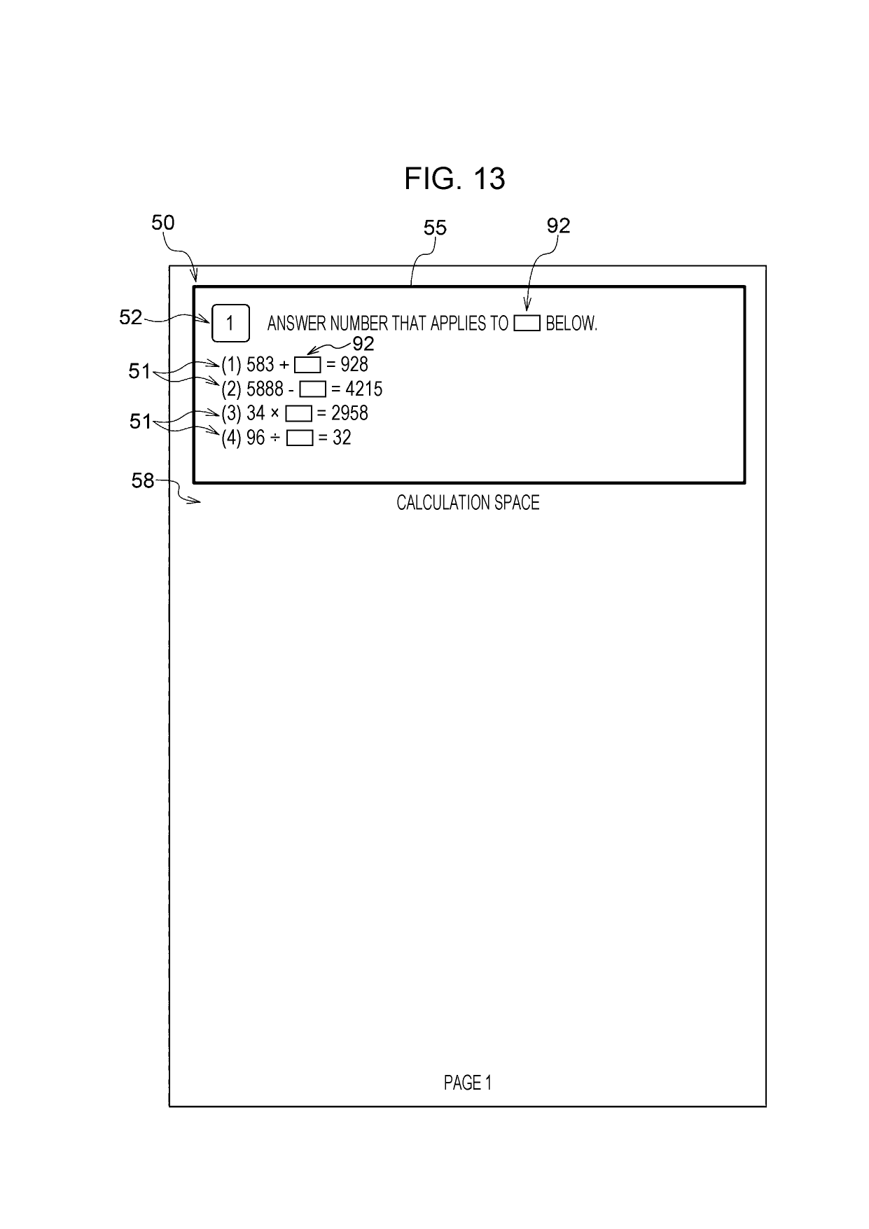

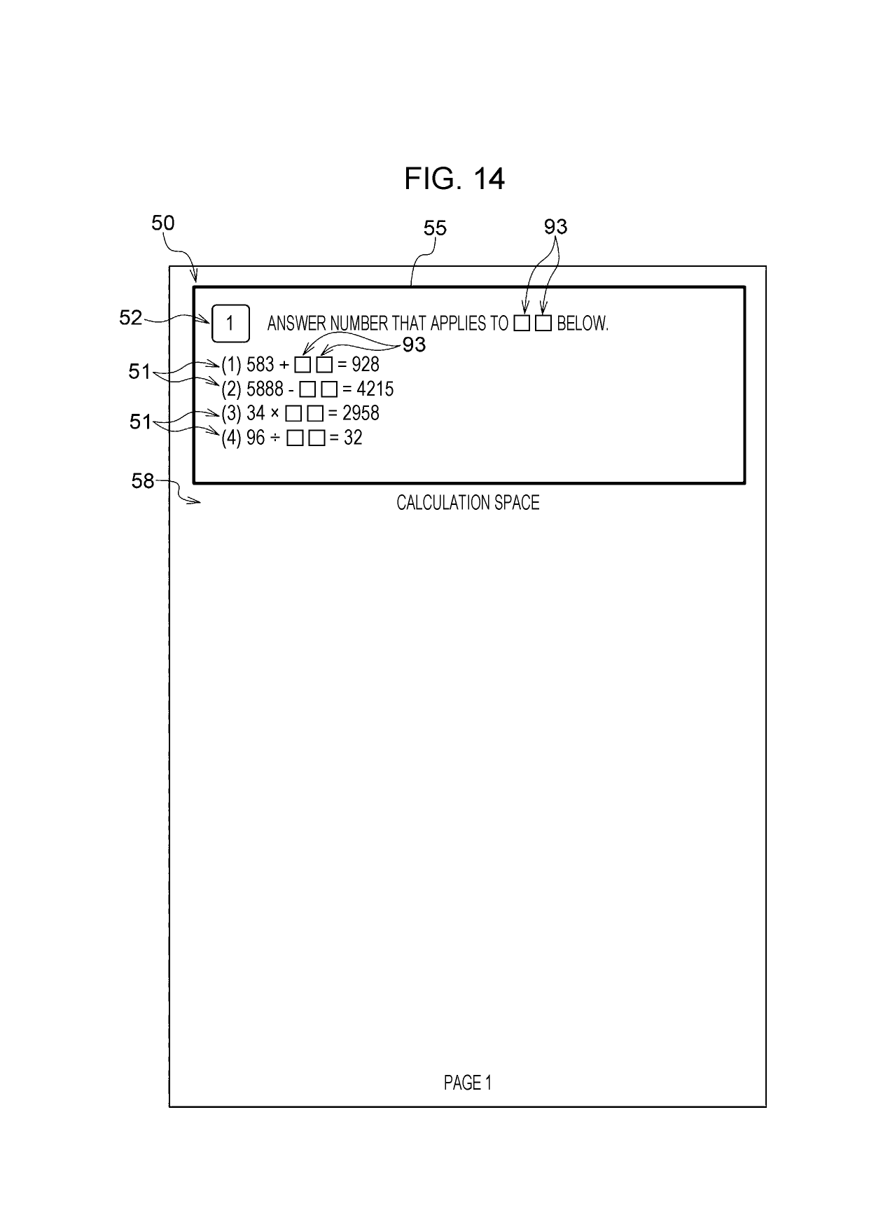

For example, when a blank space 92 is represented by a rectangular graphic as illustrated in FIG. 13, the CPU 21 converts the blank space 92 into a blank 93 in the character information as illustrated in FIG. 14. When a line portion is used as a graphic representation, for example, the CPU 21 may convert the line portion into an underline in the character information.

The similar question creation model recognizes the character information of the question and outputs the character information as a similar question, and therefore, there is a case where the similar question cannot be output when the question includes a graphic. Therefore, according to the present modification, as compared to a case where the CPU 21 inputs, to the similar question creation model, the question group in which a graphic has not been converted, it is easy to construct the similar question group in which the plurality of similar questions output from the similar question creation model is arranged according to the arrangement basis.

The similar question creation model may be capable of recognizing image information including a graphic and may output character information and image information as a similar question. In this case, the CPU 21 may input, to the similar question creation model, a question group in which a graphic has not been converted.

According to the present exemplary embodiment, in step S104, the CPU 21 executes the division processing when at least a part of the division units is a unit having a plurality of questions, but the present disclosure is not limited thereto. For example, the CPU 21 may perform division processing when all of the division units are units having only one question. Thus, for example, the CPU 21 may divide the question group for each sub-question.

According to the present exemplary embodiment, in step S104, the CPU 21 divides the question group into a plurality of division units based on the basis information that is included in the read image and is set by the user, but the present disclosure is not limited thereto. For example, the CPU 21 may divide the question group into a plurality of division units based on the preset basis information.

According to the present exemplary embodiment, in step S108, the CPU 21 inputs the content information together with the question group for each division unit to the similar question creation model of the server device 13, but the present disclosure is not limited thereto. The CPU 21 may be configured to always input only a question group to the similar question creation model.

According to the present exemplary embodiment, in step S108, the CPU 21 inputs the classification as the content information set by the user together with the question group to the similar question creation model for each division unit, but the present disclosure is not limited thereto. For example, the CPU 21 may be configured to input the preset content information to the similar question creation model.

According to the present exemplary embodiment, the CPU 21 executes the reading processing (step S101) and the conversion processing (step S102) in order to obtain a question from the collection of questions as character information, but the present disclosure is not limited thereto. For example, when the question can be previously acquired as character information, the reading processing and the conversion processing need not be executed.

### Other Modifications

The present disclosure is not limited to the above-described exemplary embodiments, and various changes, modifications, and improvements may be made without departing from the spirit of the disclosure. For example, a plurality of modifications may be combined as appropriate.

According to the present exemplary embodiment, a single question (i.e., sub-question) is used as the unit information, but the present disclosure is not limited thereto. The unit information may be a single haiku, tanka, sentence, or the like, and various types of information may be a target. The information is not limited to information including characters but may be information including images. That is, as the unit information, information that forms one unit including at least one of a character and an image is used. The image includes a graphic.

According to the present exemplary embodiment, the information processing system 10 includes the multifunction peripheral 12 and the server device 13, but the present disclosure is not limited thereto. The reading unit 31 and the printing unit 32 of the multifunction peripheral 12 may be configured as separate devices, such as a reading device and a printing device. The multifunction peripheral 12 itself may be regarded as an example of an information processing system. Therefore, the information processing system is not limited to a system configured by a plurality of devices and may be a system configured by a single device. That is, the "system" according to the present exemplary embodiment may be configured by a plurality of apparatuses or a single apparatus.

According to the above exemplary embodiment, the processor refers to processors in a broad sense and includes general-purpose processors (for example, the above-described CPU) and dedicated processors (for example, graphics processing unit (GPU), application specific integrated circuit (ASIC), field programmable gate array (FPGA), and programmable logic devices).

In addition, the operation of the processor according to the exemplary embodiment described above may be performed not only by one processor but also by a plurality of processors existing at physically separated positions in cooperation with each other. For example, the processor according to the present disclosure may be regarded as being implemented by the CPU 21 and the CPU 81 described above. The order of operations performed by the processor is not limited to the order described in the above exemplary embodiment and may be changed as appropriate.

Further, the program may be software such as firmware or microcode. The program may be, for example, a program module group, and the functions thereof may be implemented by processors configured to implement the respective functions. The program may be program code or multiple code segments stored in one or more non-transitory computer readable media (for example, a storage medium or another storage). The program may be stored in such a divided manner in multiple non-transitory computer readable media present in apparatuses physically away from each other. The program code or the code segments may represent a procedure, a function, a sub program, a routine, a subroutine, a module, a software package, a class or any combination of instructions, data structures, or program statements. The program code or the code segment may be connected to another code segment or a hardware circuit by transmitting and/or receiving information, data, an argument, a parameter, or memory content. The program according to the present disclosure may be provided as a program product.

### Appendix

### (((1)))

An information processing system comprising a processor configured to:

divide, into a plurality of division units, an information group in which a plurality of pieces of unit information that includes at least one of a character and an image and forms one unit is arranged according to a predetermined arrangement basis; and

input the information group for each of the division units to a similar information creation model that outputs similar information, which is similar to the unit information, when the unit information is input and cause the similar information to be output for each of the division units.

### (((2)))

The information processing system according to (((1))), wherein at least a part of the division units is a unit having a plurality of pieces of the unit information.

### (((3)))

The information processing system according to (((1))) or (((2))), further comprising a reading unit that reads the information group from a printed material on which the information group is printed, wherein

the processor is configured to divide the information group into a plurality of division units based on a read image of the information group read by the reading unit.

### (((4)))

The information processing system according to (((3))), wherein the processor is configured to divide the information group into a plurality of division units based on basis information that is included in the read image and is set by a user.

### (((5)))

The information processing system according to any one of (((1))) to (((4))), wherein the processor is configured to input content information indicating content of the information group together with the information group to the similar information creation model for each of the division units and cause the similar information to be output for each of the division units.

### (((6)))

The information processing system according to (((5))), wherein the processor is configured to input classification as the content information set by the user together with the information group to the similar information creation model for each of the division units.

### (((7)))

The information processing system according to any one of (((1))) to (((6))), wherein

the unit information includes a character and a graphic, and

the processor is configured to input the information group in which the graphic has been converted into a symbol to the similar information creation model for each of the division units and cause the similar information to be output for each of the division units.

### (((8)))

The information processing system according to any one of (((1))) to (((7))), wherein the processor is configured to construct a similar information group in which a plurality of pieces of similar information output from the similar information creation model is arranged according to the arrangement basis.

### (((9)))

The information processing system according to (((8))), further comprising a printing unit that prints the similar information group on a recording medium.

### (((10)))

The information processing system according to any one of (((1))) to (((9))), wherein

the information group is a question group in which a plurality of questions is arranged, and

the processor is configured to:

divide the question group into a plurality of division units; and

input the question group to the similar information creation model for each of the division units and cause a similar question that is similar to the question to be output for each of the division units.

### (((11)))

The information processing system according to (((10))), wherein

the processor is configured to:

divide the question group into main questions each having a plurality of sub-questions as the questions; and

input the question group to the similar information creation model for each of the main questions and cause the similar question to be output for each of the main questions.

### (((12)))

The information processing system according to (((10))) or (((11))), wherein

the information group is the question group further having a suggested answer to the question, and

the processor is configured to:

divide the question group into a plurality of division units;

input the question group to the similar information creation model for each of the division units;

cause the similar question and a similar suggested answer that is similar to the suggested answer to be output for each of the division units; and

separately present the similar question and the similar suggested answer to a user.

### (((13)))

A program causing a computer to execute a process for information processing, the process comprising:

dividing, into a plurality of division units, an information group in which a plurality of pieces of unit information that includes at least one of a character and an image and forms one unit is arranged according to a predetermined arrangement basis; and

inputting the information group for each of the division units to a similar information creation model that outputs similar information, which is similar to the unit information, when the unit information is input and causing the similar information to be output for each of the division units.

### (((14)))

An information processing method comprising: dividing, into a plurality of division units, an information group in which a plurality of pieces of unit information that includes at least one of a character and an image and forms one unit is arranged according to a predetermined arrangement basis; and inputting the information group for each of the division units to a similar information creation model that outputs similar information, which is similar to the unit information, when the unit information is input and causing the similar information to be output for each of the division units.

What is claimed is:

1. An information processing system comprising a processor configured to:
divide, into a plurality of division units, an information group in which a plurality of pieces of unit information that includes at least one of a character and an image and forms one unit is arranged according to a predetermined arrangement basis; and
input the information group for each of the division units to a similar information creation model that outputs similar information, which is similar to the unit information, when the unit information is input and cause the similar information to be output for each of the division units.

2. The information processing system according to claim 1, wherein at least a part of the division units is a unit having a plurality of pieces of the unit information.

3. The information processing system according to claim 1, further comprising a reading unit that reads the information group from a printed material on which the information group is printed, wherein
the processor is configured to divide the information group into a plurality of division units based on a read image of the information group read by the reading unit.

4. The information processing system according to claim 3, wherein the processor is configured to divide the information group into a plurality of division units based on basis information that is included in the read image and is set by a user.

5. The information processing system according to claim 1, wherein the processor is configured to input content information indicating content of the information group together with the information group to the similar information creation model for each of the division units and cause the similar information to be output for each of the division units.

6. The information processing system according to claim 5, wherein the processor is configured to input classification as the content information set by the user together with the information group to the similar information creation model for each of the division units.

7. The information processing system according to claim 1, wherein
the unit information includes a character and a graphic, and
the processor is configured to input the information group in which the graphic has been converted into a symbol to the similar information creation model for each of the division units and cause the similar information to be output for each of the division units.

8. The information processing system according to claim 1, wherein the processor is configured to construct a similar information group in which a plurality of pieces of similar information output from the similar information creation model is arranged according to the arrangement basis.

9. The information processing system according to claim 8, further comprising a printing unit that prints the similar information group on a recording medium.

10. The information processing system according to claim 1, wherein
the information group is a question group in which a plurality of questions is arranged, and
the processor is configured to:
divide the question group into a plurality of division units; and
input the question group to the similar information creation model for each of the division units and cause a similar question that is similar to the question to be output for each of the division units.

11. The information processing system according to claim 10, wherein
the processor is configured to:
divide the question group into main questions each having a plurality of sub-questions as the questions; and
input the question group to the similar information creation model for each of the main questions and cause the similar question to be output for each of the main questions.

12. The information processing system according to claim 10, wherein
the information group is the question group further having a suggested answer to the question, and
the processor is configured to:
divide the question group into a plurality of division units;
input the question group to the similar information creation model for each of the division units;
cause the similar question and a similar suggested answer that is similar to the suggested answer to be output for each of the division units; and
separately present the similar question and the similar suggested answer to a user.

13. A non-transitory computer readable medium storing a program causing a computer to execute a process for information processing, the process comprising:
dividing, into a plurality of division units, an information group in which a plurality of pieces of unit information that includes at least one of a character and an image and forms one unit is arranged according to a predetermined arrangement basis; and
inputting the information group for each of the division units to a similar information creation model that outputs similar information, which is similar to the unit information, when the unit information is input and causing the similar information to be output for each of the division units.

14. An information processing method comprising:
dividing, into a plurality of division units, an information group in which a plurality of pieces of unit information that includes at least one of a character and an image and forms one unit is arranged according to a predetermined arrangement basis; and
inputting the information group for each of the division units to a similar information creation model that outputs similar information, which is similar to the unit information, when the unit information is input and causing the similar information to be output for each of the division units.
